(19) United States
(12) Patent Application Publication
(10) Pub. No.: US 2018/0345396 A1
(43) Pub. Date: Dec. 6, 2018

(54) MACHINE COMPONENTS AND METHODS OF FABRICATING AND REPAIRING

(71) Applicant: GENERAL ELECTRIC COMPANY, Schenectady, NY (US)

(72) Inventors: Srikanth Chandrudu KOTTILINGAM, Greenville, SC (US); Yan CUI, Greer, SC (US); Brian Lee TOLLISON, Honea Path, SC (US); David Edward SCHICK, Greenville, SC (US); Steven John BARNELL, Pelzer, SC (US)

(21) Appl. No.: 15/612,274

(22) Filed: Jun. 2, 2017

(51) Int. Cl. B23K 1/00; F01D 5/22; F01D 5/00

(52) U.S. Cl. CPC B23K 1/0018; F01D 5/225; F01D 5/005; B23K 2201/001; F05D 2230/22; F05D 2230/237; Y10T 428/12861

(57) ABSTRACT

A method of fabricating a component includes preparing at least a portion of a surface of the component and forming a pre-sintered preform hybrid hardface mixture comprising combining a predetermined portion of at least one hardfacing material with a predetermined portion of at least one brazing material. The method further includes forming a pre-sintered preform using additive manufacturing, the pre-sintered preform having a near-net shape and forming a sintered preform. The method further includes positioning the sintered preform on the component and fixedly coupling the sintered preform to at least a portion of the component via brazing.

### FIELD OF THE INVENTION

The present invention relates generally to fabricating machine components and more particularly, to methods and apparatus for forming a hardfacing layer on a machine component.

### BACKGROUND OF THE INVENTION

Most known turbine blades are coupled to a central hub that is attached to a driven shaft and the blades are substantially radially disposed with respect to the axis of the hub and shaft. The blades include an airfoil and a high energy, driving fluid impacts the airfoils and imparts a rotational energy that in turn rotates the shaft. Some known gas turbine blades have shrouds at the outer extremities of the associated airfoils. The blade shrouds are nested in close proximity to each other. Many known turbine blade shrouds have a mechanical interlocking feature in the form of a notch, often referred to a “Z-notch” due to its shape closely resembling the letter Z that allows each blade to be physically interlocked at its shroud with an adjacent blade.

There are a variety of mechanisms that may cause wear in the region of the Z-notches. For example, during operation of the engine there may be minute, but continuous, vibration of adjacent blades with respect to each other and the hub. The aforementioned interlocking feature facilitates mitigation of airfoil vibration such that the stresses induced within the blades during operation are in turn mitigated. Since the vibration in the blades is mitigated by the close tolerances of the shroud's Z-notches, this condition may increase wear in the vicinity of the shroud's Z-notches as the adjacent notches rub against each other.

Further, during engine starting operations, as the temperatures of the shrouds, airfoils, and hub (as well as all other components that interface with the fluid) vary within each individual component and with respect to other adjacent components, and the engine is accelerated to an operating speed, the blades and shrouds will twist such that the notches will at times contact each other, i.e., attain an interlocked condition. Also, during engine stopping operations there will be a variation in component temperatures substantially reversed from the variations associated with startup as well as an engine deceleration such that the blades and shrouds will twist so that the notches will not contact each other, i.e., attain a non-interlocked condition.

In general, shroud materials do not have the hardness characteristics to withstand the long-term cumulative effects of contact and rubbing. The surface materials of the notches tend to wear. As the notches wear, the effects of the aforementioned twisting and vibration will increase and maintenance shutdowns and repairs may be more frequent. Therefore, a protective material that is compatible with the substrate material and has an increased hardness characteristic, as compared to the substrate materials, to facilitate a decrease in the susceptibility of the notch regions to wear typically is utilized with the Z-notches. This process is often referred to as hardfacing and the associated materials used are referred to as hardfacing materials. The hardface material layers can be formed by welding, spraying or brazing. In general, spray methods may not offer the long-term results achieved by some welding and brazing methods.

Hardfacing using fusion welding methods, including gas tungsten arc welding (GTAW), laser and plasma arc welding methods, have a potential to introduce variables into the hardfacing process that mitigates against repeatability of defect-free layer formation. This situation tends to increase the number and the length of post-weld inspections and weld remediation activities. For example, welding defects typically include weld cracking, porous hardface layers, poor hardface bonding and adhesion, oxidizing of the hardface material and the substrate, and cracking of the substrate due to the creation of a heat affected zone.

### SUMMARY OF THE INVENTION

In an embodiment, a method of fabricating a component includes preparing at least a portion of a surface of the component and forming a pre-sintered preform hybrid hardface mixture comprising combining a predetermined portion of at least one hardfacing material with a predetermined portion of at least one brazing material. The method further includes forming a pre-sintered preform using additive manufacturing, the pre-sintered preform having a near-net shape and forming a sintered preform. The method further includes positioning the sintered preform on the component and fixedly coupling the sintered preform to at least a portion of the component via brazing.

In another embodiment, a method of fabricating a gas turbine hot gas path component including preparing at least a portion of a surface of the component and forming a pre-sintered preform hybrid hardface mixture comprising combining a predetermined portion of at least one hardfacing material with a predetermined portion of at least one brazing material. The method further includes forming a pre-sintered preform using additive manufacturing, the pre-sintered preform having a near-net shape and forming a sintered preform. The method further includes positioning the sintered preform on the component; and fixedly coupling the sintered preform to at least a portion of the component via brazing.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a side perspective view of a section of an exemplary gas turbine engine;

FIG. 2 is a fragmentary overhead perspective view of a plurality of turbine blade shrouds without hardfacing that may be used with the gas turbine engine in FIG. 1;

FIG. 3 is a flow chart of an exemplary method for hardfacing the turbine blade shrouds in FIG. 2;

FIG. 4 is an overhead perspective view of a pre-sintered preform flat plate that may be applied to the turbine blade shrouds in FIG. 2;

FIG. 5 is a fragmentary perspective view of a shroud in FIG. 2 with a coupled sintered hardface preform; and

FIG. 6 is fragmentary overhead perspective view of the turbine blade shrouds with hardfacing that may be used with the gas turbine engine in FIG. 1.

Wherever possible, the same reference numbers will be used throughout the drawings to represent the same parts.

### DETAILED DESCRIPTION OF THE INVENTION

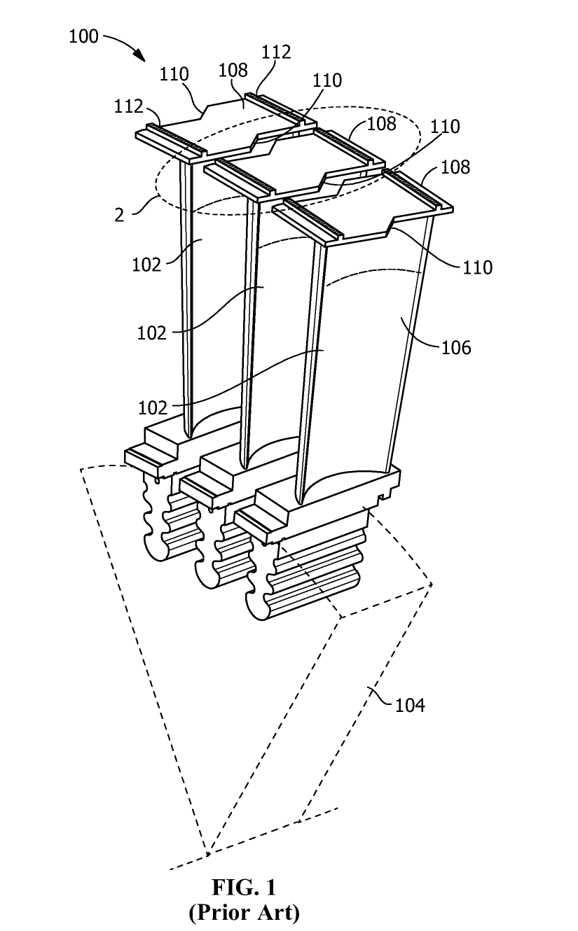

FIG. 1 is a side perspective view of a section of an exemplary gas turbine engine 100. Engine 100 has a plurality of turbine blades 102 coupled to a hub 104. In the exemplary embodiment, blades 102 are third stage buckets. Hub 104 is coupled to a turbine shaft (not shown in FIG. 1). Each of blades 102 have a corresponding airfoil 106 and a corresponding turbine blade shroud 108 fixedly coupled to airfoil 106 at the radially outermost extremity of airfoil 106. Each shroud 108 has two correspondingly opposite Z-notches 110 with only one for each shroud 108 illustrated. Protrusions 112 facilitate coupling a substantially arcuate seal ring (not shown in FIG. 1) to shrouds 112 to facilitate mitigation of blade 102 circumferential movement and vibration. The portion of FIG. 1 enclosed by the bold dotted line and labeled 2 is illustrated in FIG. 2.

In one embodiment, engine 100 is a MS9001FA engine, sometimes referred to as a 9FA engine, commercially available from General Electric Company, Greenville, S.C. The present invention is not limited to any one particular engine and may be implanted in connection with other engines including, for example, the MS6001FA (6FA), MS6001B (6B), MS6001C (6C), MS7001FA (7FA), MS7001FB (7FB), and MS9001FB (9FB) engine models of General Electric Company.

FIG. 2 is a fragmentary overhead perspective view of turbine blade shrouds 108 without hardfacing that may be used with gas turbine engine 100. Shrouds 108 are illustrated with Z-notches 110 on each end. Z-notches 110 have a mating surface 114. Airfoil 106 (in outline) and protrusions 112 are illustrated to provide perspective on the orientation.

Shrouds 108 have a substrate that may be formed of a superalloy material. The superalloy is typically a nickel-based or a cobalt-based alloy, wherein the amount of nickel or cobalt in the superalloy is the single greatest element by weight. Illustrative nickel-based superalloys include at least approximately 40 weight percent nickel (Ni), and at least one component from the group consisting of cobalt (Co), chromium (Cr), aluminum (Al), tungsten (W), molybdenum (Mo), titanium (Ti), tantalum (Ta), Niobium (Nb), hafnium (Hf), boron (B), carbon (C), and iron (Fe). Examples of nickel-based superalloys may be designated by, but not be limited to the trade names Inconel®, Nimonic®, Rene® (e.g., Rene®80-, Rene®95, Rene®142, and Rene®N5 alloys), and Udimet®, and include directionally solidified and single crystal superalloys. Illustrative cobalt-base superalloys include at least about 30 weight percent Co, and at least one component from the group consisting of nickel, chromium, aluminum, tungsten, molybdenum, titanium, and iron. Examples of cobalt-based superalloys are designated by the trade names Haynes®, Nozzaloy®, Stellite® and Ultimet®.

FIG. 3 is a flow chart of an exemplary method 200 for hardfacing turbine blade shrouds 108, and more specifically, the associated Z-notches 110 (shown in FIG. 2). Method step 202 of exemplary method 200 is preparing surface 114 (shown in FIG. 2) of turbine blade shroud Z-notch 110. Step 202, as performed on a shroud 108 that has never been placed into service within engine 100, includes a sub-step for removing any loose surface contaminants that may have collected during service. These surface contaminates may include loose dust and grit deposited during storage. Step 202 also has a sub-step for removing applied coating materials. During the fabrication process, any coatings applied to blade 102 (shown in FIG. 1) may have also deposited on surface 114. Step 202 also has a sub-step for removing surface oxides that may have formed on blade 102 during service. Generally, subsequent steps of method 200 that include material bonding processes may be negatively impacted by the presence of turbine blade coatings. Also, step 202 includes a sub-step for removal of metallurgical impurities from Z-notch mating surface 114, for example, oxidized surface layers that may have been formed during blade 102 fabrication and storage. Furthermore, step 202 has a sub-step for removing surface irregularities typically formed during the fabrication process. Generally, the methods for preparing the surface as described above use mild detergents, mild abrasives, and light machining.

Alternatively, method step 202 may be performed on a shroud 108 that has seen service within engine 100, has been removed for inspection and is scheduled to undergo repair. Prior to performing step 202, it is assumed that shrouds 108 have been removed from engine section 100 using disassembly practices well known in the art. Shroud 108 may be separated from airfoil 106 to facilitate performing further method steps associated with shrouds 108. Alternatively, shrouds 108 may remain coupled to airfoil 106 to facilitate combining a variety of maintenance activities associated with blade 102. Prior to performing the sub-steps as described above, shroud 108 may need additional preparatory sub-steps. While placed in-service, shrouds 108 experience a variety of environmental conditions that may alter the substrate material condition, for example, small cracks may develop due to temperature gradients induced during operational transients. These additional sub-steps include removing sub-surface material deformations. For removing deformations that are nearer the surface, grinding the machine component substrate surface to form a mating surface using a mild abrasive may be more advantageous. For those deformations that are deeper from the surface, grinding at least a portion of the machine component substrate surface using a pneumatically- or electrically-powered grinder may be more advantageous. An additional sub-step is filling surface voids formed by the grinding activities described above or nominal pitting formed during in-service operation as a result of physical interaction with the high energy fluid and any potentially entrained particulate contaminants. Filling the voids is typically performed by forming a layer of a material compatible with the substrate material on Z-notch mating surface 114. Furthermore, an additional sub-step is mitigating surface irregularities by machining the surface to predetermined dimensions. This sub-step is normally performed with light machining using mild abrasives.

Method step 204 of exemplary method 200 is forming a pre-sintered preform (PSP) hybrid hardface mixture. Step 204 includes combining a predetermined portion of at least one hardfacing material with a predetermined portion of at least one brazing material to form a hybrid hardface material. In the exemplary embodiment, the hardface material is Tribaloy T800 in powdered form. T800 is a cobalt-based hardface alloy produced by Deloro Stellite Inc., Belleville, Ontario, Canada and is commercially available from WESGO Ceramics, a division of Morgan Advanced Ceramics, Haywood, Calif. T800 has the following constituents by their approximate weight in %:

| | |
|---|---|
| Co | Balance |
| Mo | 27.00-30.00 |
| Cr | 16.50-18.50 |
| Si | 3.00-3.80 |
| Fe | 1.50 Maximum |
| Ni | 1.50 Maximum |
| O | 0.15 Maximum |
| C | 0.08 Maximum |
| P | 0.03 Maximum |
| S | 0.03 Maximum |

The chromium content of the T800 powder facilitates a mitigation of oxidation and corrosion.

Alternatively, Coast Metal 64, sometimes referred to as CM-64 and CM64, may be used. CM-64 is commercially available from WESGO Ceramics, a division of Morgan Advanced Ceramics, Haywood, Calif. CM-64 has the following constituents by their approximate weight in %:

| | |
|---|---|
| Co | Balance |
| Cr | 26.00-30.00 |
| W | 18.00-21.00 |
| Ni | 4.00-6.00 |
| V | 0.75-1.25 |
| C | 0.70-1.00 |
| B | 0.005-0.10 |
| Fe | 3.00 Maximum |
| Mg | 1.00 Maximum |
| Si | 1.00 Maximum |
| Mo | 0.50 Maximum |

In the exemplary embodiment, the brazing material is MAR M-509B in powdered form. M-509B is commercially available from WESGO Ceramics, a division of Morgan Advanced Ceramics, Haywood, Calif. M-509B is a cobalt-based braze alloy with a boron additive and has the following constituents by their approximate weight in %:

| | |
|---|---|
| Co | Balance |
| Cr | 22.00-24.75 |
| Ni | 9.00-11.00 |
| W | 6.50-7.60 |
| Ta | 3.00-4.00 |
| B | 2.60-3.16 |
| C | 0.55-0.65 |
| Zr | 0.30-0.60 |
| Ti | 0.15-0.30 |
| Fe | 1.30 Maximum |
| Si | 0.40 Maximum |
| Mn | 0.10 Maximum |
| S | 0.02 Maximum |

The significance of the aforementioned boron additive is described below.

In an exemplary embodiment, the brazing material is AMS 4783 (BCo-1) in powdered form. Cobalt based “low melt,” i.e., lower melting temperature powders are preferred since they have better wear properties than their nickel based counterparts, such as AMS 4782, and the cobalt based low melts work well with the cobalt based “high melts,” i.e., high melting temperature.

In the exemplary embodiment the ratio of T-800/CM-64 to MAR-M-509B or AMS 4783 is 80%-85% T-800/CM-64 to 20%-15% MAR-M-509B or AMS 4783. Alternatively, ratios of T-800/CM-64 to MAR-M-509B or AMS 4783 of 90%-60% T-800/CM-64 to 10%-40% MAR-M-509B may be used. As the percentage of MAR-M-509B is increased, the brazing temperature and wear resistance properties of the compound tend to decrease. As the percentage of AMS 4783 is increased, the brazing temperature and wear resistance properties of the compound tend to decrease, although the wear resistant properties of the compound with AMS 4783 are better compared to the wear resistant properties of the compound with MAR-M-509B.

Method step 206 of exemplary method 200 is forming a pre-sintered preform (PSP). Step 206 includes forming the PSP hybrid hardface mixture in a near-net shape using or utilizing additive manufacturing or an additive manufacturing technique. Suitable additive manufacturing techniques, which are known by those in the art include, but are not limited to, direct metal laser melting (DMLM), direct metal laser sintering (DMLS), selective laser melting (SLM), electron beam melting (EBM), binder jet powder metal processing, any other additive manufacturing technique, or a combination thereof.

For example, the DMLM technique includes distributing a first layer of a material to a selected region, selectively laser melting the first layer, distributing at least one additional layer of the material over the first layer, and selectively laser melting each of the at least one additional layers.

In another example, binder jet powder metal processing includes selectively depositing a liquid binding agent to selectively join powder particles within a portion of a powder layer, then adding one or more additional powder layers and selectively depositing the liquid binding agent over each of the additional powder layers. The selective deposition of the liquid binding agent over each of the additional powder layers selectively joins the powder particles within a portion of the powder layer and/or between the powder layers, forming the pre-sintered preform. The liquid binding agent joins the powder particles without the addition of heat during the build process and/or without a build plate. In one embodiment, the binding layer is cured in an air oven (approximately 375-400° F. for 4-24 hours), after which pre-sintered preform is removed from the surrounding powder bed, followed by sintering of the pre-sintered preform to remove the binder and increase the density of the final part, and optionally, hot isostatic pressing (HIP) the sintered preform to eliminate internal porosity or other defects.

Each of the additive manufacturing techniques forms a near-net shape structure. As used herein “near-net shape” means that the pre-sintered preforms, which are formed into sintered preform as discussed in further detail below, are formed in the exact final shape or at least very close to the final shape (especially after becoming sintered preforms), and generally not requiring traditional finishing techniques such as machining or grinding following the additive manufacturing. Alternatively, electrical discharge machining (EDM) may be used as a finishing technique, in which EDM obtains a desired shape by removing material by using electrical discharges. However, EDM requires a follow-up operation (e.g., grit blasting) to remove a “recast layer” that develops during the EDM process. Additive manufacturing techniques do not require such follow-up operations, saving time and reducing manufacturing costs. The near-net shape of the pre-sintered preforms (and sintered preforms) may be uniform, substantially uniform, or varied, and include any suitable cross-sectional shape. Although shown generally as a rectangular plate, as will be appreciated by those skilled in the art, the pre-sintered preforms are not so limited and may include square, triangular, octagonal, round, circular, semi-circular, cylindrical, conical, hourglass shaped, parabolic shaped, hollow, any other geometric shape, or a combination thereof.

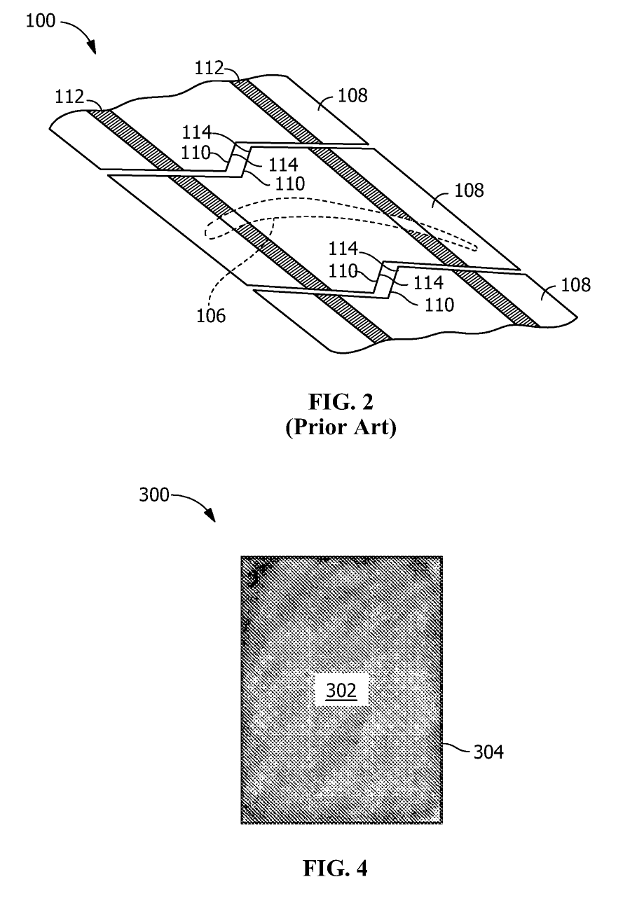

Method step 208 of exemplary method 200 is forming a sintered preform. Step 208 includes a sub-step of sintering the PSP. Sintering the preform is performed by heating the PSP to a predetermined temperature for a predetermined period of time in a thermostatically-controlled sintering furnace in order to attain a porosity of less than 2% in the sintered preform, as well as removing the accumulation of binder during PSP manufacturing. Normal PSP is made by mixing the powder together and applying a binder. This results in a “felt” like material that can then be made into sheets, and during the sintering operation the binder is burned off leaving solid metal behind. The powders do not substantially melt during sintering. During the high temperature sintering heat treatment, individual spheres of powder plastically deform around each other causing voids to coalesce. The braze and hardface powders in the hybrid hardface mixture are permitted to mix, with each other to form a substantially homogeneous mixture of both powders. Upon completion of sintering, the sintered preform is allowed to cool. FIG. 4 is an overhead perspective view of a generally rectangular-shaped assembly 300 that includes a generally rectangular-shaped sintered preform 302 that may be applied to turbine blade shrouds Z-notches 110 (shown in FIG. 2). Sintered preform 302 is illustrated resting on a forming tray 304. Step 208 also has a second sub-step of extracting a sintered preform (not shown in FIG. 4) from forming tray 304. The sintered preform is extracted from the forming tray 304 by using either a laser cutting tool or a water jet cutting tool. As previously discussed, the sintered preform has a near-net shape that is virtually identical to the desired shape for Z-notch 110 such that traditional finishing techniques are generally not required.

In summary, with conventional methods, the powder and binder mix are formed into sheets having a predetermined thickness, requiring subsequent machining and possibly, follow-up processing as a result of undesired effects of the machining. Once the sheet is cut to size, the resulting pieces are PSPs. In the present invention, the powder is mixed together and a PSP is directly formed having a selectively contoured near net shape, thereby avoiding the process of sheet forming, subsequent machining and follow-up processing.

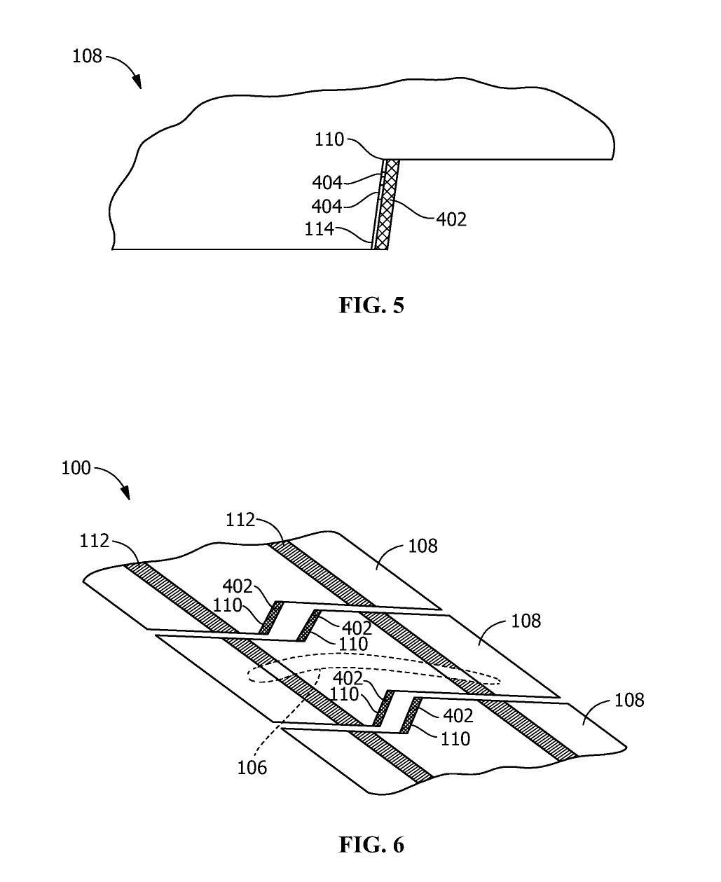

Method step 210 of exemplary method 200 is positioning the sintered preform on turbine blade shroud Z-notch 110. FIG. 5 is a fragmentary perspective view of shroud 108 with a coupled sintered hardface preform 402. Preform 402 is held in place on mating surface 114 of Z-notch 110 by at least one discrete tack weld 404. In the exemplary embodiment, two tack welds are used to facilitate preform 402 adherence to surface 114. Generally, the number of tack welds is held to one or two welds to mitigate formation of heat affected zones on surface 114 and to mitigate deformation of preform 402. Typically, a welding torch (not shown in FIG. 5) is sufficiently powerful to form tack welds 404 through hardface preform 402 while forming substantially only localized melting of the substrate at mating surface 114 at tack weld 404 locations.

Alternatively, as is known in the art, a layer of material with a predetermined thickness and chemical makeup may be inserted between preform 402 and surface 114 to facilitate bonding. For example, a thin foil of commercially available nickel-based alloy Amdry 915 with a chemistry of Ni 13Cr 4Si 4Fe 3B may be used. The thickness of the thin foil may be approximately 1 millimeter (mm) (0.04 inches (in)) to 5 mm (0.20 in) and the other dimensions may be substantially similar to the dimensions of surface 114.

Method step 212 of exemplary method 200 is brazing sintered preform 402 to Z-notch mating surface 114. Step 212 includes a heating cycle sub-step and a cooling cycle sub-step. The heating cycle sub-step includes at least one rate of heat addition, at least one holding temperature and at least one holding period. In the exemplary embodiment, the heating cycle sub-step includes placing shroud 108, with preform 402 tack welded to each of its two Z-notches 110, into a brazing furnace that is at room temperature, i.e., approximately 21° Celsius (C) (70° Fahrenheit (F)). To facilitate the bonding process, a non-oxidizing atmosphere within the furnace may be provided per methods well known to practitioners of the art. To obtain a non-oxidizing atmosphere, a vacuum is formed in the furnace with a pressure of approximately 0.067 Pascal (Pa) (0.5 milliTorr) or less. The furnace is heated to approximately 980° C. (1800° F.) at a rate of approximately 14° C./minute (25° F./minute). Once approximately 980° C. (1800° F.) is attained, this temperature is maintained for approximately 30 minutes. Then the furnace temperature is increased to approximately 1204 to 1218° C. (2200 to 2225° F.) at a rate of between approximately 1° C./minute (2° F./minute) and approximately 19° C./minute (35° F./minute). Once approximately 1204 to 1218° C. (2200 to 2225° F.) is attained, this temperature is maintained between approximately 10 minutes and approximately 30 minutes.

The cooling cycle sub-step includes at least one holding temperature and at least one holding period. In the exemplary embodiment, the cooling cycle sub-step includes a controlled cooling of the brazing furnace with shroud 108 inside to approximately 1120° C. (2050° F.) and maintaining that temperature for approximately 60 minutes. The furnace is subsequently cooled to approximately room temperature.

In an alternative embodiment, step 212 may be performed in conjunction with other heat treatment activities to reduce a manufacturing schedule. For example, shrouds 108 undergoing additional or other maintenance and repair activities may also use step 212 as a method of relieving stress. Also, alternatively, heat treatment of airfoils 106 may be performed in conjunction with shrouds 108.

Step 212 of exemplary method 200 can utilize boron (B) to achieve several beneficial results. In a first beneficial result, the addition of boron in the alloy acts as a melting point suppressant, permitting the low melt portion of the PSP (approximately 10-25 weight percent) to melt near the brazing temperature (approximately 2225° F. in this example). The low melt portion melts during the brazing and performs mostly like a normal braze alloy. However, the high melt portion (T800/CM64) does not melt during the brazing. This high melt portion keeps the structure intact, i.e., ensures the PSP remains in solid form after brazing as before. In a second beneficial result, due at least partially due to the boron (B) concentration in the MAR M-509B brazing powder, a strong bond between hardface preform 402 and mating surface 114 is facilitated. Step 212 uses a form of diffusion bonding in which sustained yielding and creep of the surfaces of the materials being bonded at elevated temperatures facilitates removal of substantially all voids between the two materials. The boron tends to diffuse from hardface preform 402 into mating surface 114 thereby facilitating the diffusion bonding process. In general, the greater the amount of boron that has diffused through the materials and the greater the distance the stronger the bond. In the exemplary embodiment, boron diffusion facilitates a diffusion bond between 76 micrometers (μm) (0.003 inches) and 127 μm (0.005 inches) as compared to hardfacing using fusion welding methods, including tungsten inert gas (TIG), laser and plasma arc welding methods, which provide substantially no diffusion bonding. In the exemplary embodiment the shear strength, i.e., the force that a material or a bond can withstand prior to failing, of the exemplary bond is between 89,600 kilopascals (kPa) (13 kips per square inch (ksi)) at approximately 704° C. (1300° F.) and 93,800 kPa (13.6 ksi) at approximately room temperature. This range is compared to the shear strength of the substrate alone at 927° C. (1700° F.) of approximately 100,663 kPa (14.6 ksi).

Alternatively, in order to further facilitate method step 212, method step 210 may include inserting a layer of a boron-containing material between mating surface 114 and preform 402 to increase the concentration of diffused boron in the bond. Also, alternatively, the brazing powder described in method step 204 may have the boron concentration increased to facilitate the diffusion bonding process. Furthermore, alternatively, an additional boron-containing powder may be mixed with the exemplary braze and hardface powders in method step 204.

In addition to improved bonding characteristics, advantages over the aforementioned welding methods include mitigation of porosity of the hardface material. This is due to having a single consistent layer formed while welding typically has multiple layers formed in a dynamic method with inconsistent layer formation. Additional advantages include elimination of creation of heat affected zones and subsequent weld-induced cracking. Weld-induced cracking of alloys poses a significant problem, such as with tungsten inert gas (TIG) welding, although alloy cracking is also extremely problematic with manual welding and even laser welding. A further advantage includes mitigation of oxidizing of the substrate and hardface material since a non-oxidizing environment is used to form the hardface layer.

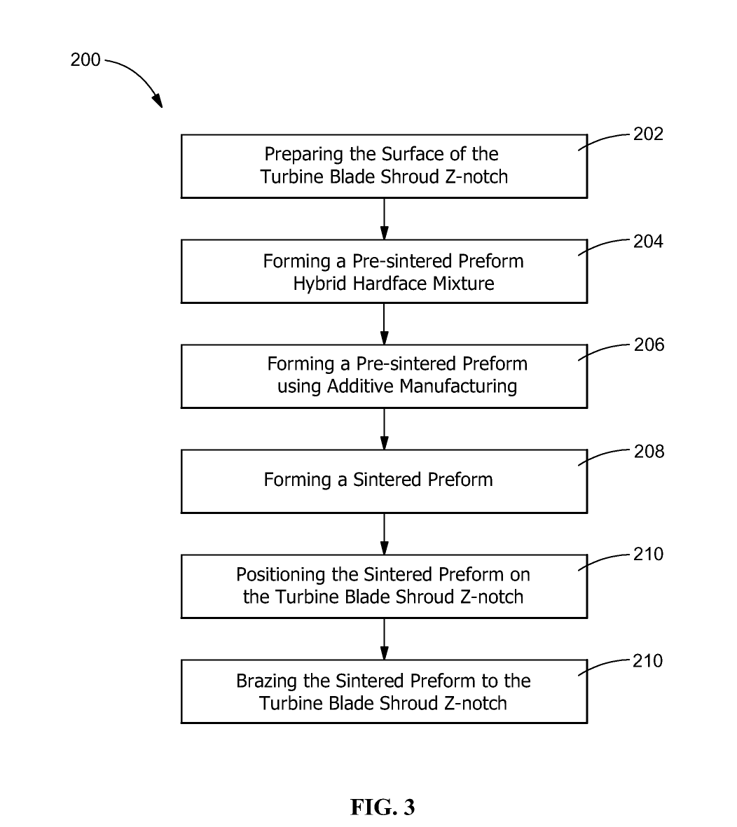

FIG. 6 is fragmentary overhead perspective view of turbine blade shrouds 108 that may be reinstalled in gas turbine engine 100 with hardfacing 402 in Z-notches 110. Prior to reinstalling shrouds 108 into engine 100, minor machining of hardfacing 402 may be performed to mitigate surface irregularities and to facilitate hardfacing dimensioning to be substantially similar to the associated dimensions of mating surface 114.

The methods and apparatus for a fabricating a turbine blade described herein facilitates operation of a turbine system. More specifically, hardfacing the turbine blade as described above facilitates a more robust, wear-resistant and reliable turbine blade. Such blade also facilitates reliability, and reduced maintenance costs and turbine system outages.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A method of fabricating a component comprising:
preparing at least a portion of a surface of the component;
forming a pre-sintered preform hybrid hardface mixture comprising combining a predetermined portion of at least one hardfacing material with a predetermined portion of at least one brazing material;
forming a pre-sintered preform using additive manufacturing, the pre-sintered preform having a near-net shape;
forming a sintered preform;
positioning the sintered preform on the component; and
fixedly coupling the sintered preform to at least a portion of the component via brazing.

2. The method of claim 1, wherein forming a sintered preform further includes the sintered preform having a porosity of less than 2%.

3. The method of claim 1, wherein forming a pre-sintered preform using additive manufacturing includes additive manufacturing techniques selected from the group consisting of direct metal laser melting (DMLM), direct metal laser sintering (DMLS), selective laser melting (SLM), electron beam melting (EBM), binder jet powder metal processing, and combinations thereof.

4. The method of claim 1, wherein preparing at least a portion of a surface comprises removing loose surface contaminants, applied coating materials, surface oxides and surface irregularities from at least a portion of the surface of the component.

5. The method of claim 1, wherein positioning the sintered preform comprises tack welding at least a portion of the sintered preform to at least a portion of the surface of the component.

6. The method of claim 1, wherein fixedly coupling the sintered preform comprises heat treating the component and the sintered preform, said heat treating comprising a heating cycle and a cooling cycle, the heating cycle having at least one rate of heat addition, at least one holding temperature and at least one holding period, the cooling cycle having at least one holding temperature and at least one holding period.

7. The method of claim 1, wherein said forming a pre-sintered preform hybrid hardface mixture further comprises combining a portion of at least one hardfacing material between approximately 90% by weight and approximately 60% by weight with a portion of at least one brazing material between approximately 10% by weight and approximately 40% by weight.

8. The method of claim 7, wherein the at least one hardfacing material is composed of T800 or CM64, and the at least one brazing material is taken from the group consisting of MAR M-509B and AMS 4783.

9. The method of claim 1, wherein said forming a pre-sintered preform hybrid hardface mixture further comprises combining a portion of at least one hardfacing material between approximately 80% by weight and approximately 85% by weight with a portion of at least one brazing material between approximately 20% by weight and approximately 15% by weight.

10. The method of claim 9, wherein the at least one hardfacing material is composed of T800 or CM64, and the at least one brazing material is taken from the group consisting of MAR M-509B and AMS 4783.

11. The method of claim 1, wherein said fixedly coupling the sintered preform further comprises: heating the component and the sintered preform from approximately 1800° F. to between approximately 2200° F. and approximately 2255° F. at a rate of heat addition of between approximately 2° F. per minute and approximately 35° F. per minute; and heating the component and the sintered preform at a holding temperature of between approximately 2200° F. and approximately 2255° F. for a holding period of between approximately 10 minutes and approximately 30 minutes.

12. The method of claim 11, wherein said fixedly coupling the sintered preform further comprises: reducing the heat of the component to approximately 2050° F.; and maintaining a holding temperature of approximately 2050° F. for a holding period of approximately 60 minutes, wherein boron contained in at least one of the at least one brazing material and additional boron-containing powder facilitates a diffusion bond between the sintered preform and the component.

13. A method of fabricating a gas turbine hot gas path component comprising:
preparing at least a portion of a surface of the component;
forming a pre-sintered preform hybrid hardface mixture comprising combining a predetermined portion of at least one hardfacing material with a predetermined portion of at least one brazing material;
forming a pre-sintered preform using additive manufacturing, the pre-sintered preform having a near-net shape;
forming a sintered preform;
positioning the sintered preform on the component; and
fixedly coupling the sintered preform to at least a portion of the component via brazing.

14. The method of claim 13, wherein the component is a turbine blade.

15. The method of claim 13, wherein forming a pre-sintered preform using additive manufacturing includes additive manufacturing techniques selected from the group consisting of direct metal laser melting (DMLM), direct metal laser sintering (DMLS), selective laser melting (SLM), electron beam melting (EBM), binder jet powder metal processing, and combinations thereof.
